(19) United States
(12) Patent Application Publication
(10) Pub. No.: US 2016/0279800 A1
(43) Pub. Date: Sep. 29, 2016

(54) ROBOT, ROBOT CONTROL DEVICE, AND ROBOTIC SYSTEM

(71) Applicant: Seiko Epson Corporation, Tokyo (JP)

(72) Inventor: Kenji ONDA, Azumino (JP)

(21) Appl. No.: 15/071,581

(22) Filed: Mar. 16, 2016

(30) Foreign Application Priority Data
Mar. 27, 2015 (JP) 2015-065915

(51) Int. Cl. B25J 9/16

(52) U.S. Cl. CPC B25J 9/1697

(57) ABSTRACT

A robot includes an arm, to which a tool can be attached, and which is capable of moving the tool to a position where the tool and a reference point can be imaged by a first imaging section and a second imaging section, and the arm is controlled using an offset of the tool to the arm, the offset being derived based on first image data of an image of the tool attached to the arm and the reference point taken by the first imaging section at each of three or more positions of the tool, and second image data of an image of the tool attached to the arm and the reference point taken by the second imaging section at each of the three or more positions of the tool.

### BACKGROUND

1. Technical Field

The present invention relates to a robot, a robot control device, and a robotic system.

2. Related Art

In general, robots are used in a state in which a tool is attached to a chuck provided to a tip portion of an arm. A reference point of the arm to which the tool is attached is referred to as a tool center point (TCP). In order to process a work by the tool, it is necessary to control the position of the tool with respect to the work. Since many of the tools are manufactured and sold by different business operators from that of a robot 1, the shapes of the tools are unknown to the manufacturer of the robot 1. In the case in which the unknown tool is attached, it is necessary to derive the offset of the tool with respect to the TCP and then set the offset to a robot control device in advance of the use of the robot. JP-A-8-85083 (Document 1) discloses a method of deriving the offset of the tool with respect to the arm. According to the method disclosed in Document 1, the tool is positioned at a reference point with three or more postures different from each other using jog feed operations by the user to thereby derive the offset of the tool based on the result of the positioning.

However, in the case of positioning the tool at the reference point using the jog feed operation, it results that the accuracy of positioning varies by the skill level of the user, and further, there is a problem that it takes considerable time to achieve positioning. The problem becomes more serious as the number of robots, for which the offsets of the tools are set, increases.

### SUMMARY

An advantage of some aspects of the invention is to make it easy to derive the offset of the tool with respect to the arm.

A robot adapted according to an aspect of the invention includes an arm, to which a tool can be attached, and which is capable of moving the tool to a position where the tool and a reference point can be imaged by a first imaging section and a second imaging section, and the arm is controlled using an offset of the tool to the arm, the offset being derived based on first image data of an image of the tool attached to the arm and the reference point taken by the first imaging section at each of three or more positions of the tool, and second image data of an image of the tool attached to the arm and the reference point taken by the second imaging section at each of the three or more positions of the tool.

According to the aspect of the invention, by moving the arm to the three or more positions, and obtaining the image data from the two imaging sections having imaged the tool and the reference point at each of the positions, the offset of the tool to the arm can be derived based on the image data thus obtained. Further, even if the tool fails to be aligned with the reference point at each of three or more positions, the offset can be derived based on the image data taken by the two imaging sections in each of the states. In other words, according to the aspect of the invention, since there is no need to align the tool with the reference point using the jog feed operation, the offset of the tool to the arm can easily be derived.

It should be noted that the function of each of the constituents described in the appended claims can be realized by a hardware resource the function of which is specified by the configuration itself, a hardware resource the function of which is specified by a program, or a combination of these hardware resources. Further, the functions of the constituents are not limited to those realized by respective hardware resources physically independent of each other.

### BRIEF DESCRIPTION OF THE DRAWINGS

The invention will be described with reference to the accompanying drawings, wherein like numbers reference like elements.

FIG. 1A is a schematic perspective view related to an embodiment of the invention. FIG. 1B is a block diagram related to the embodiment of the invention.

FIG. 2 is a plan view related to the embodiment of the invention.

FIG. 3 is a schematic perspective view related to the embodiment of the invention.

FIG. 4 is a flowchart related to the embodiment of the invention.

### DESCRIPTION OF EXEMPLARY EMBODIMENTS

Some embodiments of the invention will hereinafter be described with reference to the accompanying drawings. It should be noted that in the drawings, constituents corresponding to each other are denoted by the same symbols, and the duplicated explanation will be omitted.

### 1-1. Outline

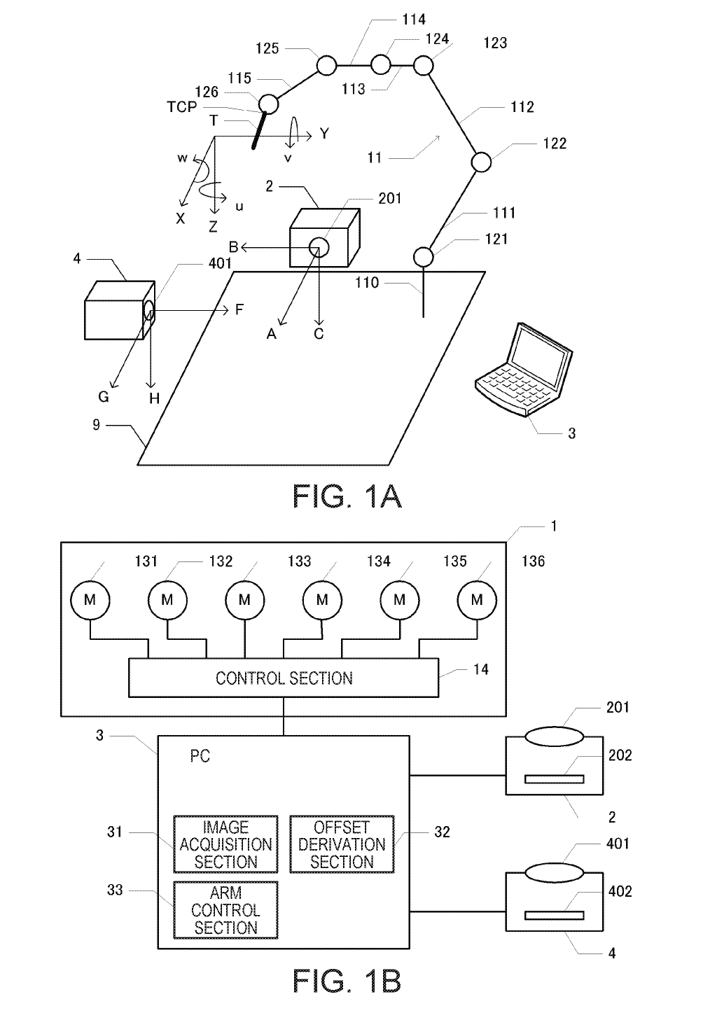

As shown in FIGS. 1A and 1B, robotic system as an embodiment of the invention is provided with a robot 1, a first imaging section 2, a second imaging section 4, and a personal computer (PC) 3 as a robot control device.

The robot 1 is a six-axis robot having an arm provided with six rotary shaft members 121, 122, 123, 124, 125, and 126. The center of the tip of the rotary shaft member 126, to which a variety of tools for operating the work are attached, is referred to as a tool center point (TCP). FIG. 1A illustrates a tool T having a rod-like shape. The position and the posture of the TCP are used as references of the position and the posture of each of a variety of tools. A coordinate system (a robot coordinate system) of the robot 1 used when controlling the robot 1 is a three-dimensional orthogonal coordinate system determined by an X axis and a Y axis each extending horizontally, and a Z axis, the positive direction of which is a vertically downward direction. Further, a rotation around the Z axis is represented by u, a rotation around the Y axis is represented by v, and a rotation around the X axis is represented by w. The unit of length of the robot coordinate system is millimeter, and the unit of angle thereof is degree.

The imaging sections 2, 4 are installed on a table 9, a wall, the ceiling, or the like in a position and a posture with which the movable range of the arm of the robot 1 can be imaged. Although the explanation is presented assuming that the configurations of the imaging sections 2, 4 are the same in the present embodiment, the configurations are not required to be the same. A coordinate system (a camera coordinate system) of the imaging section 2 (4) is a coordinate system of the image data output from the imaging section 2 (4), and is determined by a B (G) axis, the positive direction of which is a horizontally rightward direction of the image represented by the image data, and a C (H) axis, the positive direction of which is a vertically downward direction of the image represented by the image data. The unit of length of the coordinate system of the imaging section 2 (4) is pixel, and the unit of angle thereof is degree. The coordinate system of the imaging section 2 (4) is a two-dimensional orthogonal coordinate system obtained by non-linearly converting a coordinate system of a plane in a real space perpendicular to an optical axis A (F) of the imaging section 2 (4) in accordance with optical characteristics (e.g., a focal distance, and a distortion) of a lens 201 (401) and the number of pixels and the size of an area image sensor 202 (402).

The PC 3 as a robot control device is connected to the robot 1 and the imaging sections 2, 4. In order to control the robot 1 based on the image data output by the imaging sections 2, 4, a process of associating the camera coordinate system of the imaging sections 2, 4 and the robot coordinate system of the robot 1 with each other, namely a calibration, becomes necessary. Further, in the case of processing the work with the robot 1, it is necessary to control the position and the posture of the tool attached to the rotary shaft member 126. Therefore, regarding a tool, the position and the posture of which with respect to the TCP are unknown, the position and the posture of the tool with respect to the TCP are required to be set to the control device of the robot 1 before use. Therefore, a tool setting program for easily setting the offset of the tool with respect to the TCP in a shot time is installed in the PC 3.

### 1-2. Configuration

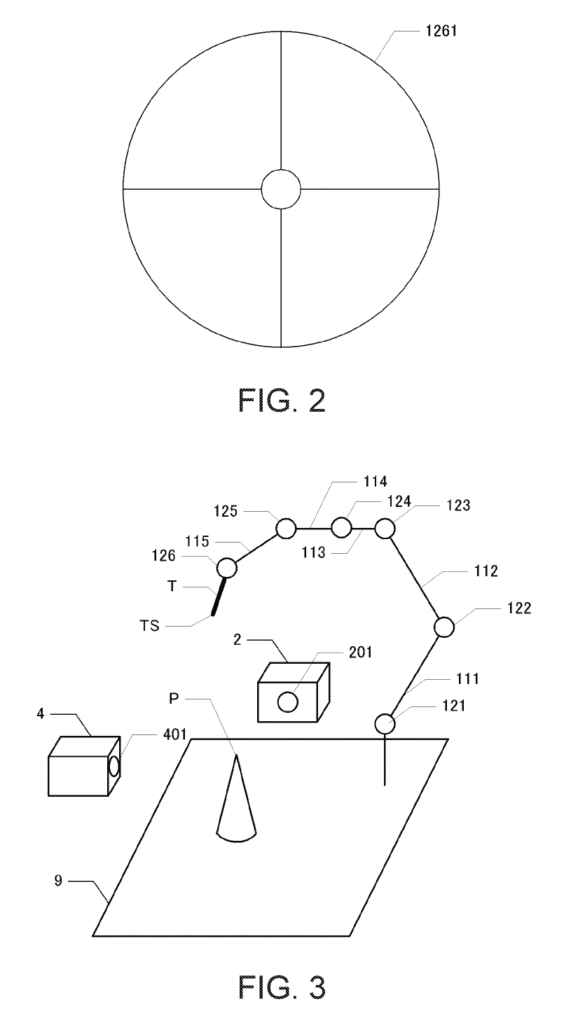

As shown in FIG. 1A in a simplified manner, the robot 1 is provided with a platform 110, and arms 111, 112, 113, 114, and 115. The platform 110 supports the rotary shaft member 121 of the first arm 111. The first arm 111 rotates with respect to the platform 110 together with the rotary shaft member 121 centered on the central axis of the rotary shaft member 121. The first arm 111 supports the rotary shaft member 122 of the second arm 112. The second arm 112 rotates with respect to the first arm 111 together with the rotary shaft member 122 centered on the central axis of the rotary shaft member 122. The second arm 112 supports the rotary shaft member 123 of the third arm 113. The third arm 113 rotates with respect to the second arm 112 together with the rotary shaft member 123 centered on the central axis of the rotary shaft member 123. The third arm 113 supports the rotary shaft member 124 of the fourth arm 114. The fourth arm 114 rotates with respect to the third arm 113 together with the rotary shaft member 124 centered on the central axis of the rotary shaft member 124. The fourth arm 114 supports the rotary shaft member 125 of the fifth arm 115. The fifth arm 115 rotates with respect to the fourth arm 114 together with the rotary shaft member 125 centered on the central axis of the rotary shaft member 125. The fifth arm 115 supports the rotary shaft member 126. The rotary shaft member 126 as the tip of a manipulator is provided with a tool chuck 1261, an attachment surface of which for a tool is shown in FIG. 2. To the tool chuck 1261, there are attached a variety of tools for operating the work. As shown in FIG. 2, the attachment surface of the tool chuck 1261 is divided into four parts, and a shaft of a tool is inserted in a central area of the attachment surface. The center of the attachment surface of the tool chuck 1261 corresponds to the TCP.

It is assumed in the present embodiment that the offset to the TCP is derived with respect to the tip TS of the tool T having a rod-like shape shown in FIG. 1A. It should be noted that the part, to which the offset should be derived, differs in accordance with the shape and a usage pattern of the tool.

As shown in FIG. 1B, the robot 1 is provided with a motor 131 for driving the rotary shaft member 121, a motor 132 for driving the rotary shaft member 122, a motor 133 for driving the rotary shaft member 123, a motor 134 for driving the rotary shaft member 124, a motor 135 for driving the rotary shaft member 125, a motor 136 for driving the rotary shaft member 126, and a control section 14 for controlling the motors 131 through 136. The motors 131 through 136 are constituents of the arms 111 though 115. The motors 131 through 136 are each a servomotor, which is feedback controlled so that the difference between a target value and a current value vanishes. The control section 14 obtains the target value representing the position and the posture of the TCP from the PC 3, and then derives target values of the motors 131 through 136 based on the target value representing the position and the posture of the TCP.

The imaging section 2 (4) is a digital camera provided with the lens 201 (401), the area image sensor 202 (402), an AD converter not shown, and so on. As shown in FIG. 1A, the imaging sections 2, 4 are installed at predetermined positions on the table 9, on which the work is mounted, so as to be able to image the movable range of the arms.

The PC 3 is a computer provided with a processor not shown, a main storage not shown and formed of a DRAM, an input/output mechanism not shown, an external storage not shown and formed of a nonvolatile memory, a display, a keyboard functioning as an instruction reception section 30, and so on. The PC 3 executes the tool setting program stored in the external storage with a processor to thereby function as an image acquisition section 31, an offset derivation section 32, and an arm control section 33.

The image acquisition section 31 instructs imaging to the imaging sections 2, 4, and then obtains the image data, which represents the image of the reference point and the tool taken in accordance with the instruction, from the imaging sections 2, 4. The reference point used in the present embodiment can arbitrarily be set in a range which can be imaged by the imaging sections 2, 4. It should be noted that it is not required to set the reference point to the PC 3 as a coordinate of the robot coordinate system. In other words, the reference point used for deriving the offset can be an unknown point to both of the robot 1 and the PC 3. In the present embodiment, a vertex P of a conical body mounted on the table 9 within the range which can be imaged by the imaging sections 2, 4 is used as the reference point for deriving the offset of the tip TS of the tool T. The reference point P set in such a manner does not move with respect to the imaging sections 2, 4, and can therefore be used as a reference for calibrating the camera coordinate system of the imaging sections 2, 4 and the robot coordinate system to each other.

The offset derivation section 32 derives the offset of the tip TS of the tool T to the TCP based on the image data taken by the imaging sections 2, 4. The details will be described later.

The arm control section 33 outputs the target value to the control section 14 of the robot 1 in accordance with the operation of the user such as the jog feed operation to thereby control the robot 1. Further, the arm control section 33 outputs the target value of the position and the posture of the TCP determined in advance, and the target value of the position and the posture of the TCP derived by the offset derivation section 32 to the control section 14 of the robot 1 to thereby align the reference point P and the tip TS of the tool T with each other. The details will be described later.

### 2. Tool Offset Process

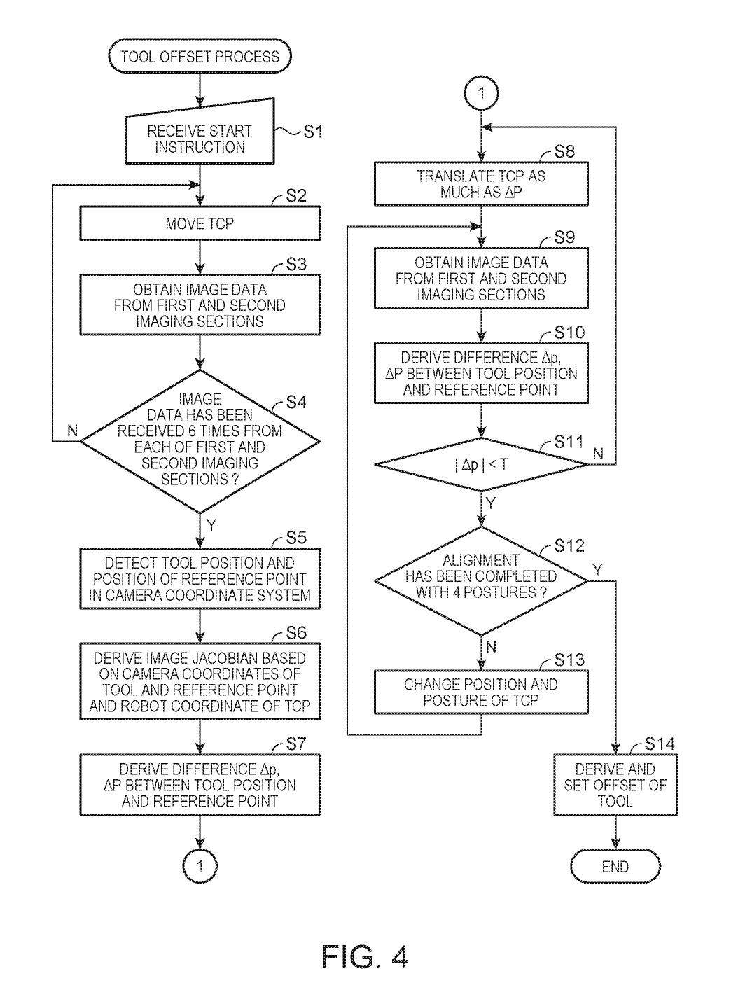

Then, a flow of a tool offset process for deriving and then setting the offset of the tip TS of the tool T to the TCP using the robot system described above will be described with reference to FIG. 4.

The tool offset process by the robot system is started (step S1) by the operator inputting a start instruction to the PC 3, and is then completed without requiring any operations to the operator, or with a simple operation. What is required for the operator before inputting the start instruction is to put the reference point P within the moving range of the tool T and within the visual fields of the imaging sections 2, 4. Further, at the time point when starting the tool offset process, it is not required for the calibration between the robot coordinate system and the camera coordinate system to be achieved, and the positions of the imaging sections 2, 4 with respect to the robot 1 can also be unknown.

When the start instruction is input (step S1) to the PC 3, the arm control section 33 moves (step S2) the TCP to the position and the posture determined in advance for deriving the image Jacobian. The position determined in advance here is only required to be located with in the visual field in which the tool T can be imaged by the imaging sections 2, 4. It is sufficient to, for example, show a rough setting position of the reference point P with respect to the robot 1 in the manual, and then determine in advance the moving destination of the TCP to a point distant from the setting position as much as a predetermined length. Even if the reference point P is not installed as shown in the manual, the tool offset process can be executed as long as the reference point P is not installed at the position where the arm or the tool T has contact in the moving destination of the TCP determined in advance, the reference point P is not installed at the position which cannot be imaged by the imaging sections 2, 4, and the reference point P is not installed out of the moving range of the tool. It should be noted that although the image Jacobian can be derived as long as three such moving destinations of the TCP are determined in advance, in the present embodiment, in order to simplify the calculation, the following six points are determined in advance, and the TCP is moved to the points in series. As these six points, there are used the remaining six points (X±ΔX, Y, Z), (X, Y±ΔY, Z), (X, Y, Z±ΔZ) with respect to one point (X, Y, Z) determined first.

When the TCP is moved to the position and the posture determined in advance, the image acquisition section 31 instructs the first imaging section 2 and the second imaging section 4 to perform imaging to thereby obtain (step S3) the image data from the first imaging section 2 and the second imaging section 4. As a result, the image acquisition section 31 obtains the image data (first image data) of the image of the tool T attached to the TCP in the position and the posture determined in advance and the reference point P taken by the first imaging section 2, and the image data (second image data) of the image of the tool T attached to the TCP in the same position and the same posture and the reference point P taken by the second imaging section 4.

The process in the steps S2 and S3 is repeatedly performed until the process is repeated six times due to the determination (step S4) of the number of repetitions. In the step S2, different one of the points determined in advance is set every time as the moving destination of the TCP. When the process of the steps S2 and S3 has been repeated six times, there is obtained the state in which the six image data (the first image data) of the images of the tool T attached to the TCP of the arm and the reference point P taken by the first imaging section 2 and the six image data (the second image data) of the images of the tool T attached to the TCP of the arm and the reference point P taken by the second imaging section 4 are obtained by the image acquisition section 31 in the six states different in the position of the TCP from each other and the same in the posture of the TCP.

When the image acquisition section 31 has obtained the total of 12 image data, the offset derivation section 32 detects (step S5) the position of the tip TS of the tool T in the camera coordinate system with respect to each of the image data. In order to detect the tip TS of the tool T from the image data, it is necessary that the shape of the tip TS of the tool T has previously been known, and it is preferable to allow the tool and the reference point to have an arbitrary shape. Therefore, it is preferable to previously prepare a mark having a shape determined in advance, and then assist the operator to attach the mark to the tool and the reference point using the manual or the like. It is sufficient to, for example, prepare two types of balls having adhesion in the attachment surface and colored to be high in chromaticness as the marks, and attach one to the tool, and the other to the reference point. Further, for example, a small-sized LED illumination device having adhesion in the attachment surface can also be used as the mark. Further, a solid object having a shape determined in advance can also be prepared for setting the reference point. In the case of using such marks, it is possible for the offset derivation section 32 to detect the position of the tip TS of the tool T and the position of the reference point P in the camera coordinate system by the template matching using templates corresponding respectively to the shapes of the marks.

When the position of the tip TS of the tool T has been detected in the camera coordinate system with respect to each of the 12 image data, the offset derivation section 32 derives (step S6) the image Jacobian for performing the coordinate conversion from the robot coordinate system to the camera coordinate system. Since the six positions of the tip TS of the tool T are recorded in the three image data taken by the first imaging section 2, the camera coordinates representing the six positions are detected with respect to the tip TS of the tool T. Further, the position of the TCP when each of the image data is taken by the first imaging section 2 and the second imaging section 4 is known in the robot coordinate system.

Here, the image Jacobian for converting the robot coordinate (X, Y, Z) into the camera coordinate (x₁, y₁) of the first imaging section 2 and the camera coordinate (x₂, y₂) of the second imaging section 4 is defined as follows.

$$\begin{matrix}Formula 1 & \\ Image Jacobian \text{:} J = [ \begin{matrix}\frac{\partial {x}_{1}}{\partial X} & … & \frac{\partial {x}_{1}}{\partial Z} \\ ⋮ & ⋱ & ⋮ \\ \frac{\partial {y}_{2}}{\partial X} & … & \frac{\partial {y}_{2}}{\partial Z}\end{matrix} ] & ( 1 ) \\ Formula 2 & \\ where & \\ [ \begin{matrix}{x}_{1} \\ {y}_{1} \\ {x}_{2} \\ {y}_{2}\end{matrix} ] = [ \begin{matrix}\frac{\partial {x}_{1}}{\partial X} & … & \frac{\partial {x}_{1}}{\partial Z} \\ ⋮ & ⋱ & ⋮ \\ \frac{\partial {y}_{2}}{\partial X} & … & \frac{\partial {y}_{2}}{\partial Z}\end{matrix} ] [ \begin{matrix}X \\ Y \\ Z\end{matrix} ] & ( 2 )\end{matrix}$$

The offset derivation section 32 substitutes the camera coordinates of the twelve points detected at the positions of the TCP and the robot coordinates of the TCP in Formulas 3 through 14 to thereby derive the image Jacobian J.

$$\begin{matrix}Formula 3 & \\ \frac{\partial {x}_{1}}{\partial X} = \frac{{x}_{1 + Δ x} - {x}_{1 - Δ x}}{( + Δ X ) - ( - Δ X )} = \frac{{x}_{1 + Δ x} - {x}_{1 - Δ x}}{2 Δ X} & ( 3 ) \\ Formula 4 & \\ \frac{\partial {y}_{1}}{\partial X} = \frac{{y}_{1 + Δ x} - {yx}_{1 - Δ x}}{( + Δ X ) - ( - Δ X )} = \frac{{y}_{1 + Δ x} - {y}_{1 - Δ x}}{2 Δ X} & ( 4 ) \\ Formula 5 & \\ \frac{\partial {x}_{2}}{\partial X} = \frac{{x}_{2 + Δ x} - {x}_{2 - Δ x}}{( + Δ X ) - ( - Δ X )} = \frac{{x}_{2 + Δ x} - {x}_{2 - Δ x}}{2 Δ X} & ( 5 ) \\ Formula 6 & \\ \frac{\partial {y}_{2}}{\partial X} = \frac{{y}_{2 + Δ x} - {y}_{2 - Δ x}}{( + Δ X ) - ( - Δ X )} = \frac{{y}_{2 + Δ x} - {y}_{2 - Δ x}}{2 Δ X} & ( 6 ) \\ Formula 7 & \\ \frac{\partial {x}_{1}}{\partial Y} = \frac{{x}_{1 + Δ y} - {x}_{1 - Δ y}}{( + Δ Y ) - ( - Δ Y )} = \frac{{x}_{1 + Δ y} - {x}_{1 - Δ y}}{2 Δ Y} & ( 7 ) \\ Formula 8 & \\ \frac{\partial {y}_{1}}{\partial Y} = \frac{{y}_{1 + Δ y} - {y}_{1 - Δ y}}{( + Δ Y ) - ( - Δ Y )} = \frac{{y}_{1 + Δ y} - {y}_{1 - Δ y}}{2 Δ Y} & ( 8 ) \\ Formula 9 & \\ \frac{\partial {x}_{2}}{\partial Y} = \frac{{x}_{2 + Δ y} - {x}_{2 - Δ y}}{( + Δ Y ) - ( - Δ Y )} = \frac{{x}_{2 + Δ y} - {x}_{2 - Δ y}}{2 Δ Y} & ( 9 ) \\ Formula 10 & \\ \frac{\partial {y}_{2}}{\partial Y} = \frac{{y}_{2 + Δ y} - {y}_{2 - Δ y}}{( + Δ Y ) - ( - Δ Y )} = \frac{{y}_{2 + Δ y} - {y}_{2 - Δ y}}{2 Δ Y} & ( 10 ) \\ Formula 11 & \\ \frac{\partial {x}_{1}}{\partial Z} = \frac{{x}_{1 + Δ z} - {x}_{1 - Δ z}}{( + Δ Z ) - ( - Δ Z )} = \frac{{x}_{1 + Δ z} - {x}_{1 - Δ z}}{2 Δ Z} & ( 11 ) \\ Formula 12 & \\ \frac{\partial {y}_{1}}{\partial Z} = \frac{{y}_{1 + Δ z} - {y}_{1 - Δ z}}{( + Δ Z ) - ( - Δ Z )} = \frac{{y}_{1 + Δ z} - {y}_{1 - Δ z}}{2 Δ Z} & ( 12 ) \\ Formula 13 & \\ \frac{\partial {x}_{2}}{\partial Z} = \frac{{x}_{2 + Δ z} - {x}_{2 - Δ z}}{( + Δ Z ) - ( - Δ Z )} = \frac{{x}_{2 + Δ z} - {x}_{2 - Δ z}}{2 Δ Z} & ( 13 ) \\ Formula 14 & \\ \frac{\partial {y}_{2}}{\partial Z} = \frac{{y}_{2 + Δ z} - {y}_{2 - Δ z}}{( + Δ Z ) - ( - Δ Z )} = \frac{{y}_{2 + Δ z} - {y}_{2 - Δ z}}{2 Δ Z} & ( 14 )\end{matrix}$$

When the image Jacobian has been derived, the offset derivation section 32 derives a vector Δp from the tip TS of the tool T to the reference point P in the camera coordinate system, and then obtains (step S7) a vector ΔP for moving the tip TS of the tool T to the reference point P in the robot coordinate system using the inverse matrix J⁻¹ of the image Jacobian J.

Here, defining the position of the tip TS of the tool T as (Tx₁, Ty₁), and the position of the reference point P as (Gx₁, Gy₁) in the camera coordinate system of the first imaging section 2, and defining the position of the tip TS of the tool T as (Tx₂, Ty₂), and the position of the reference point P as (Gx₂, Gy₂) in the camera coordinate system of the second imaging section 4, the vector Δp is derived by Formula 15 below.

$$\begin{matrix}Formula 15 & \\ Δ p = [ \begin{matrix}Δ {x}_{1} \\ Δ {y}_{1} \\ Δ {x}_{2} \\ Δ {y}_{2}\end{matrix} ] = [ \begin{matrix}{Gx}_{1} \\ {Gy}_{1} \\ {Gx}_{2} \\ {Gy}_{2}\end{matrix} ] - [ \begin{matrix}{Tx}_{1} \\ {Ty}_{1} \\ {Tx}_{2} \\ {Ty}_{2}\end{matrix} ] & ( 15 )\end{matrix}$$

The vector ΔP for moving the tip TS of the tool T to the reference point P is derived by Formula 16 below.

Formula 16

ΔP=J⁻¹Δp (16)

When the offset derivation section 32 has derived the vector ΔP for moving the tip TS of the tool T to the reference point P, the arm control section 33 translates (step S8) the TCP as much as ΔP. If no error exists in the detected positions of the tip TS of the tool T and the reference position P, no calculation error exists in the derivation process of the image Jacobian, and no error exists in the control of the arm with respect to the target value ΔP, the tip TS of the tool T moves to the reference point P when moving the TCP as much as ΔP. In this case, the relative position of the reference point P to the TCP having been moved corresponds to the offset of the tip TS of the tool T to the TCP. Specifically, the relationship between the position of the tip TS of the tool T and the position of the TCP on the image data taken by the two imaging sections 2, 4 does not become clear in the robot coordinate system, and the offset of the tip TS of the tool T to the TCP is not obtained until the tip TS of the tool T has contact with the reference point P. However, if it is assumed that the vector ΔP is correctly obtained, the position of the TCP in the state in which the tip TS of the tool T has contact with the reference point P can be derived, and therefore, the offset of the tip TS of the tool T to the TCP can be obtained without making the tip TS of the tool T have contact with the reference point P by translating the TCP as much as ΔP. It should be noted that the coordinate (GX, GY, GZ), which is derived by Formula 17 from the position (Gx₁, Gy₁) of the tip TS of the tool T having been detected in the camera coordinate system of the first imaging section 2, and the position (Gx₂, Gy₂) of the tip TS of the tool T having been detected in the camera coordinate system of the second imaging section 4 before the movement, represents the position of the tip TS of the tool T in the robot coordinate system before the movement.

$$\begin{matrix}Formula 17 & \\ [ \begin{matrix}GX \\ GY \\ GZ\end{matrix} ] = {J}^{- 1} [ \begin{matrix}{Gx}_{1} \\ {Gy}_{1} \\ {Gx}_{2} \\ {Gy}_{2}\end{matrix} ] & ( 17 )\end{matrix}$$

If the TCP is moved as much as ΔP, there is a possibility that the tool T collides with the reference point P. Therefore, in order to prevent the reference point P and the tool T from having contact with each other, it is also possible to move the TCP as much as an amount obtained by subtracting a vector, which has previously been determined so that the tool T stops without fail immediately before having contact with the reference point P, from the vector ΔP.

When the TCP has been moved as much as ΔP, the image acquisition section 31 instructs the first imaging section 2 and the second imaging section 4 to perform imaging to thereby obtain (step S9) the image data from the first imaging section 2 and the second imaging section 4.

When the image data has been obtained from the first imaging section 2 and the second imaging section 4, the offset derivation section 32 derives the vector Δp from the tip TS of the tool T to the reference point P in the camera coordinate system, and then obtains (step S10) the vector ΔP for moving the tip TS of the tool T to the reference point P in the robot coordinate system using the inverse matrix J⁻¹ of the image Jacobian J similarly to the step S7.

Then, the offset derivation section 32 determines (step S11) whether or not the magnitude of the vector Δp is smaller than a threshold value T determined in advance. The smaller the threshold value T is determined, the higher the derivation accuracy of the offset becomes on the one hand, and the higher the possibility that the tool T collides with the reference point P becomes on the other hand. It is sufficient to set the threshold value T to an appropriate value in advance taking the above into consideration.

In the case in which it has been determined in the step S11 that the magnitude of the vector Δp is not smaller than the threshold value T determined in advance, the process of the steps S8, S9, S10, and S11 described above is repeated. Therefore, the image acquisition section 31, the offset derivation section 32, and the arm control section 33 align the tool T with the reference point P using the visual feedback control of the arm based on the image data obtained from the first imaging section 2 and the second imaging section 4.

In the case in which it has been determined in the step S11 that the magnitude of the vector Δp is smaller than the threshold value T determined in advance, the offset derivation section 32 determines (step S12) whether or not the magnitude of the vector Δp, which has been derived in the step S10, has become smaller than the threshold value T determined in advance with respect to each of four postures of the tool T different from each other. Then, if the magnitude of the vector Δp has not become smaller than the threshold value T determined in advance with respect to each of four postures of the tool T different from each other, the arm control section 33 changes the position and the posture of the TCP, and the process of the steps S9 through S12 is repeated.

In the step S13, the TCP is moved away from the reference point P within the visual field of the first imaging section 2 and the second imaging section 4, and at the same time, the posture of the TCP is changed to a posture different from the posture having ever been imaged by the first imaging section 2 or the second imaging section 4, and then the TCP is moved to a position determined in advance until the determination result that the magnitude of the vector Δp is smaller than the threshold value T determined in advance is obtained four times in the step S11. When viewed from the coordinate fixed to the TCP, the offset of the tip TS of the tool T to the TCP is constant irrespective of the posture of the TCP. However, the posture of the tool T imaged in the image data varies in accordance with the posture of the TCP, and there is a possibility that the position detection accuracy of the tip TS of the tool T also varies in accordance with the posture of the tool T imaged in the image data. Therefore, when measuring the distance from the reference point P with respect to the tip TS of the tool T based on the image data taken by the first imaging section 2 and the second imaging section 4, the measurement accuracy is enhanced by performing the detection a plurality of times with the posture of the tool T changed.

If the determination result that the magnitude of the vector Δp is smaller than the threshold value T determined in advance is obtained four times in different postures in the step S11, the offset derivation section 32 derives and then sets (step S14) the position of the reference point P with respect to the TCP in the robot coordinate system as the offset of the tip TS of the tool T to the TCP. The position of the reference point P relative to the TCP is derived by adding the vector ΔP obtained finally in the step S10 to the coordinate obtained by converting the position of the reference point P detected in the step S11 from the camera coordinate system to the robot coordinate system using the inverse matrix of the image Jacobian.

According to the embodiment of the invention described hereinabove, by moving the TCP to three or more positions in the steps S2 through S4, and obtaining the image data from the two imaging sections 2, 4 having imaged the tool T and the reference point P at each of the positions, the offset of the tool to the TCP can be derived based on the image data thus obtained in the steps S5 through S7. Further, even if the tool T fails to be aligned with the reference point P at each of three or more positions, the offset can be derived based on the image data taken by the two imaging sections 2, 4 in each of the states. In other words, since there is no need to align the tip TS of the tool T with the reference point P using the jog feed operation, it is possible to easily derive and then set the offset of an arbitrary tool to the arm in a short time.

Further, since it is also automatically performed by the arm control section 33 to move the TCP to the three or more positions for each of the postures of the tool in the steps S2 through S4, it is easier to set the offset. Further, since the tool T is aligned with the reference point P using the visual feedback control of the arm based on the image data obtained from the two imaging sections 2, 4 in the steps S8 through S11, the distance from the tip TS of the tool T to the reference point P can accurately be measured compared to the case of deriving the offset to the TCP based on the distance from the tip TS of the tool T to the reference point P derived in the step S7. Therefore, the offset can be derived with high accuracy. Further, since the distance from the tip TS of the tool T to the reference point P can more accurately be measured by repeating the steps S9 through S11 a plurality of times with the initial position and the posture of the TCP changed, the offset can be derived with higher accuracy.

### 3. Other Embodiments

It should be noted that the scope of the invention is not limited to the embodiment described above, but it is obvious that a variety of modifications can also be applied within the scope or the spirit of the invention.

For example, it is also possible to omit the process of the step S8 and the succeeding steps described above, and drive and then set the offset of the tool based on the vector ΔP having been derived in the step S7. Further, it is also possible to omit the process of the steps S12 and S13 described above, and derive and then set the offset of the tool based on the vector ΔP obtained finally at the time point when the magnitude of the vector Δp becomes smaller than the threshold value T in the step S11. Further, the number of repetitions of the process of the steps S9 through S12 is not limited to four, but can also be no larger than three or no smaller than five.

Further, it is also possible to change the posture of the TCP every time and move the position of the TCP instead of moving the TCP to the six points with the same posture in the step S2 described above.

Further, although in the embodiment described above, the same image Jacobian is used in the process of aligning the tip TS of the tool T with the reference point P four times using the visual feedback control with the posture of the tool changed, it is also possible to repeat the process starting from the step S2 with the posture of the tool T changed after determining the number of repetitions in the step S12. In other words, it is also possible to derive the image Jacobian every time the posture of the tool T is changed. In this case, it results that the image Jacobian is derived for each of the four postures in the step S6, and it results that alignment between the tool and the reference point is performed due to the visual feedback control using the image Jacobians different from each other. Therefore, it is also possible to select the vector ΔP having the smallest magnitude out of the vectors ΔP finally obtained using the respective image Jacobians before deriving the offset of the tool in the step S14, and then derive the offset of the tool based on the vector ΔP thus selected.

Further, although in the embodiment described above, the robot and the robot control device are provided separately and then connected to each other, it is also possible to provide the function of the robot control device to the robot itself.

Further, the invention can be applied to vertical articulated robots other than the six-axis vertical articulated robot, and can also be applied to scalar robots, the rotational axes of the arms of which are all parallel to each other.

The entire disclosure of Japanese Patent Application No. 2015-065915, filed Mar. 27, 2015 is expressly incorporated by reference herein.

What is claimed is:

1. A robot comprising:
an arm, to which a tool can be attached, and which is capable of moving the tool to a position where the tool and a reference point can be imaged by a first imaging section and a second imaging section,
wherein the arm is controlled using an offset of the tool to the arm, the offset being derived based on first image data of an image of the tool attached to the arm and the reference point taken by the first imaging section at each of three or more positions of the tool, and second image data of an image of the tool attached to the arm and the reference point taken by the second imaging section at each of the three or more positions of the tool.

2. The robot according to claim 1 wherein
the tool is aligned with the reference point due to visual feedback control of the arm based on the first image data and the second image data.

3. The robot according to claim 2 wherein
the offset of the tool to the arm is derived based on a result obtained by aligning the tool with the reference point.

4. The robot according to claim 1 wherein
the first image data is different in posture of the arm between the three or more positions of the tool.

5. A robotic system comprising:
a first imaging section;
a second imaging section;
an arm, to which a tool can be attached, and which is capable of moving the tool to a position where the tool and a reference point can be imaged by the first imaging section and the second imaging section;
an image acquisition section adapted to obtain first image data of an image of the tool attached to the arm and the reference point taken by the first imaging section at each of three or more positions of the tool, and second image data of an image of the tool attached to the arm and the reference point taken by the second imaging section at each of the three or more positions of the tool; and
an offset derivation section adapted to derive an offset of the tool to the arm based on the first image data and the second image data.

6. A robot control device adapted to control a robot provided with an arm, to which a tool can be attached, and which is capable of moving the tool to a position where the tool and a reference point can be imaged by a first imaging section and a second imaging section, the robot control device comprising:
an image acquisition section adapted to obtain first image data of an image of the tool attached to the arm and the reference point taken by the first imaging section at each of three or more positions of the tool, and second image data of an image of the tool attached to the arm and the reference point taken by the second imaging section at each of the three or more positions of the tool; and
an offset derivation section adapted to derive an offset of the tool to the arm based on the first image data and the second image data.
